(19) United States
(12) Patent Application Publication
(10) Pub. No.: US 2005/0021232 A1
(43) Pub. Date: Jan. 27, 2005

(54) Motor vehicle proximity radar with extended functionality and method for operating a motor vehicle proximity radar with extended functionality

(76) Inventors: Juergen Dickmann, Ulm (DE); Michael Wagner, Ulm (DE)

Correspondence Address: Stephan A Pendorf;Pendorf & Cutliff, 5111 Memorial Highway, Tampa, FL, 33634-7356, US

(21) Appl. No.: 10/497,441

(22) PCT Filed: Nov. 9, 2002
(86) PCT No.: PCT/EP02/12542

(30) Foreign Application Priority Data
Nov. 29, 2001 (DE) 101 58 719.8

(51) Int. Cl. G06F 17/10

(52) U.S. Cl. 701/301

(57) ABSTRACT

The invention concerns a motor vehicle near range sensor with an all around view, comprising a number of individual radars (2, 2′) and a control unit (3, 3′) for controlling the individual radars (2, 2′), wherein the individual radars (2, 2′) are designed to operate in either a sensory mode or a communication mode, and wherein the control unit (3, 3′) is designed to switch at least one individual radar (2, 2′) into the communication mode as soon as a contact vehicle (1, 1′) enters the range of the motor vehicle near range radar. Beyond this, it concerns a process for operating a motor vehicle near range radar with an all around view, comprising a number of individual radars (2, 2′) and a control unit (3, 3′) for controlling the individual radars (2, 2′), which process includes the following steps: operating the individual radars (2, 2′in a sensing mode as long as no contact vehicle (1, 1′) enters the range of the motor vehicle near range radar; and switching at least one individual radar (1, 1′) into a communication mode as soon as a contact vehicle (1, 1′) enters the range of the motor vehicle near range radar.

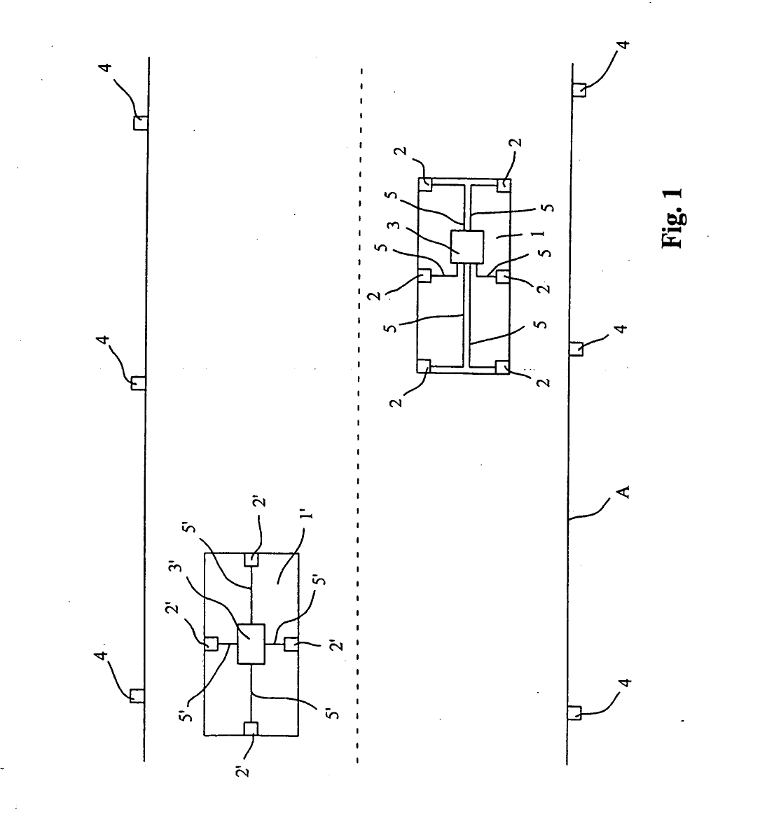

### BACKGROUND OF THE INVENTION

1. Field of Invention

The present invention concerns a motor vehicle near range radar with extended functionality as well as a process for operating a motor vehicle near range radar with extended functionality.

2. Related Art of the Invention

From the state of the art according to U.S. Pat. No. 5,835,203 a motor vehicle laser radar system is known, which is designed to provide distance measurements as well as communication between two vehicles using a single laser diode. The known laser radar system is primarily designed for communication and distance measurement from the front and rear of a vehicle.

According to U.S. Pat. No. 5,835,203, in the embodiment described therein a light beam emitted by an emitter segment is emitted from the front side of the vehicle. The same light beam of the transmitter segment is supplied to the rear of the vehicle via a switch. A control unit operates the transmitter segment switching between a distance measuring mode, in which the distance to a preceding or following vehicle is determined, and a communication mode, in which information can be exchanged between the vehicles. In U.S. Pat. No. 5,835,203 the distance measurement occurs on the basis of the determination of the time difference between the transmission of a reference signal and the reflection of this signal. Consequently, the duration or periodicity of the distance measuring mode is based on the maximal distance to be measured to the preceding or, as the case may be, the following vehicle. Finally, the determined time difference is stored in memory and is averaged, in order to display the averaged value of the distance to the operator via a suitable display device.

In U.S. Pat. 5,249,027 a system is disclosed for measuring distances between vehicles, in which an IR-sensor is provided in the front area of a vehicle. Corresponding IR-transmitters are also provided in the rear of the vehicle. The IR-transmitters operate with a wavelength of, for example, 1 μm, and are modulated over time in order to produce a binary code, which results in a better signal/noise ratio, in echo suppression and in a better range. A control unit provides the synchronization between transmitter and sensor. Therewith, the system according to U.S. Pat. No. 5,249,027 provides for distance measurement between the vehicles in the IR-range.

U.S. Pat. No. 6,151,539 describes a device and a process for autonomous control of a vehicle. The known device includes a radar sensor provided at the front of a vehicle for determining the number of objects located ahead of the vehicle, their distance from the vehicle, and their relative speed. In addition, two laser scanner-sensors are provided on the front corners and one laser scanner-sensor is provided at the rear of the vehicle. The scanning of the environment of the vehicle can be improved by locating the sensors on the vehicle roof. The entire sensor system of U.S. Pat. No. 6,151,539 is, however, directed only towards determining or acquiring the distance and the position of objects in the vicinity of the vehicle.

### SUMMARY OF THE INVENTION

It is thus the objective of the present invention to provide a motor vehicle near range radar with extended functionality as well as a process for operating a motor vehicle near range radar with extended functionality, which covers 360° and, at the same time, makes possible an efficient communication between vehicles.

In the framework of the above objective, one particular task of the present invention is the provision of a motor vehicle near range radar with extended functionality as well as a process for operating a motor vehicle near range radar with extended functionality, wherein communication takes place in particular between cooperating vehicles.

It is a further task within the framework of the above objective to provide a motor vehicle range radar, which can be employed in the framework of an ad-hoc network. Alternatively thereto, it is the task of the invention to provide a near range radar, which is employable in a cellular radio network.

These and other objects of the invention as can be found in the following description and the single FIGURE are accomplished by a motor vehicle near range radar with extended functionality as well as a process for operating a motor vehicle near range radar with extended functionality.

### BRIEF DESCRIPTION OF THE DRAWING

The single FIGURE shows a top view of the present invention on a road A, upon which vehicles equipped with the inventive motor vehicle near range radar are located.

### DETAILED DESCRIPTION OF THE INVENTION

The first vehicle, indicated with reference number 1, is equipped with a number of individual radars 2, which are arranged in the manner that they provide good 360° coverage—a good all-around view. The individual radars 2 are designed for locating and tracking objects in the immediate vicinity of the vehicle 1. The number and arrangement of the individual radars 2 is, as is well known to the person of ordinary skill in this art, dependent upon the effective direction and the sensing area or, as the case may be, sensing angle of each individual radar 2. Systems as shown in association with the vehicle 1′ are also conceivable.

Beyond this, individual radars can be positioned on the roof of the vehicle 1 or 1′ or at the level of the side trim. This applies to the sides as well as the front or rear area of the vehicle. The essential condition to be taken into consideration for the location or arrangement of the individual radars in the framework of the present invention is, as already mentioned, the good all-around view. Useful arrangements providing an all-around view are described in U.S. Pat. No. 6,151,539, of which the contents are incorporated herewith by reference.

The respective vehicles 1 and 1′ are equipped with a control unit 3, or as the case may be 3′, which controls the individual radars 2, or as the case may be 2′, via appropriate wiring or optical fibers 5 or as the case may be 5′. It is also conceivable to use a WLAN (for example, a radio network according to IEEE 802.11) for linking the individual radars and the control unit.

The individual radars can be LEDs analogous to those disclosed in U.S. Pat. No. 5,835,203 with similar sensing and communication modes. The contents of U.S. Pat. No. 5,835,203 are likewise incorporated herein by reference in their entirety.

For communication between the cooperating vehicles 1 and 1′ the communication is established via one individual radar oriented in the direction of the partner. This occurs, in accordance with the invention, on a predetermined communication protocol.

According to a particular aspect of the present invention, the individual radars 2 or as the case may be 2′ are operated by the respective control units 3 and 3′ in the sensing mode so long as no vehicle is in the respective radar range. In typical vehicle applications the radar range is, for example, not greater than 500 m, so that the transmission capacity of the individual radars is relatively limited.

As soon as a mutual detection has occurred between two vehicles, the individual radar located in the direction of the partner is switched by the control unit from the sensing mode to the communication mode and communication is established on the basis of a predetermined communication protocol. During the synchronization process necessary between the cooperating partners for establishing communications, the sensing function of the near range radar remains substantially intact. After ending communications, the involved individual radars are again switched back to the sensing mode. Thereby there is achieved, in accordance with the invention, a higher data rate at a greater range, and flexibility of communication, with minimal interference of the sampling performance of the near range radar.

The inventive motor vehicle near range radar can also be employed in combination with individual radars 4 located along the edge of the road, wherein the manner of functioning and control occurs analogously to that of the above described individual radars located in vehicles.

The inventive motor vehicle near range radar can be employed for direct communication between vehicles in the framework of an inter-vehicle radio communication network (IFFC-network), which can be achieved by so-called ad-hoc radio networks (n≧2 participants). The ad-hoc radio networks are designed in such a manner that radio systems installed in vehicles can communicate directly with each other without supplemental infrastructure, through, for example, sensing systems, sensors or the like. Herein the ad-hoc radio networks differ from cellular radio networks wherein each communication process is controlled by a central base station and communication occurs via the base station. IFFC-networks can also include fixed position installed radio stations. In contrast to the cellular network, these are however to be considered functionally equivalent to the radio systems installed in the vehicles and are not necessary for the operation of the ad-hoc radio network. IFFC-networks are generally operated in license-free radio frequencies. The radio transmissions are thus free. Thus, the IFFC-networks are in particular suited for the exchange of locally relevant data in the environment of the vehicle.

Modern commercial ad-hoc radio networks are described according to the standards ETSI HIPERLAN Type 1, IEEE 802.11 and Bluetooth. More recent progress allows expectation of an adaptation of the known processes to the area of ad-hoc radio networks for the employment in IFFC-networks.

It is particularly preferred to employ the inventive motor vehicle near range radar and process in an ad-hoc radio network for selective communication as described in pending patent application DE 101 31 839 of the present applicant under the title “Inter-Vehicle Communication Process”. The content of this application is herewith included in its entirety herein by reference.

A further current preferred application of the inventive motor vehicle near range radar and process is in the framework of cellular mobile communication systems and processes, as described by the present applicants in patent application DE 101 37 138 with the title “Mobile Communication System and Process”. The content of this application is likewise incorporated herein by reference in its entirety.

Although the inventive near range radar or, as the case may be, the process has been described in association with automobile applications, it is conceivable to apply the fundamental principles of the invention to other motor vehicles such as for example aviation or marine vehicles. Beyond this, changes can be made, without leaving the scope of the present invention, as described in the following claims.

Any reference numbers associated with features of the claims are to be understood as being merely for reference. Accordingly such reference numbers do not establish any limitations of the scope of protection of such features, which are only provided with reference numbers for exemplification purposes.

1-12 (cancelled)

13. A motor vehicle near range radar of the type comprising an individual radar and a control unit for controlling the individual radar, wherein the individual radar is designed to be operated in a sensory mode and in a communication mode, and wherein the control unit is designed to switch the individual radar to the communication mode, said motor vehicle near range sensor comprising:
a number of individual radars (2, 2′) for an all around view and
a control unit (3, 3′) for controlling the individual radars (2, 2′),
wherein the individual radars (2, 2′) are designed to be operated in a sensory mode and in a communication mode, and
wherein the control unit (3, 3′) is designed to switch at least one individual radar (2, 2′) to the communication mode as soon as a contact vehicle (1, 1′) enters the range of the motor vehicle near range radar.

14. A motor vehicle near range radar according to claim 13, wherein the control unit (3, 3′) is designed to keep the individual radars (2, 2′) in the sensory mode until a contact vehicle (1, 1′) is in the range of the motor vehicle near range radar, whereupon a switching over to the communication mode occurs only as long as the contact vehicle (1, 1′) remains within the range of the motor vehicle near range radar.

15. A motor vehicle near range radar according to claim 13, wherein the individual radars (1, 1′) and the control unit (3, 3′) are designed, when in the communication mode, to establish communication using a communication protocol.

16. A motor vehicle near range radar system, comprising:
a motor vehicle near range radar comprising a number of individual radars (2, 2′) for an all around view and a control unit (3, 3′) for controlling the individual radars (2, 2′), wherein the individual radars (2, 2′) are designed to be operated in a sensory mode and in a communication mode, and wherein the control unit (3, 3′) is designed to switch at least one individual radar (2, 2′) to the communication mode as soon as a contact vehicle (1, 1′) enters the range of the motor vehicle near range radar, and
one or more individual radars (4) positionally fixed along the edge of a road, which is/are controlled so as to be likewise switched into the communication mode as soon as the vehicle (1, 1′) enters the range of the fixed individual radar(s) (4).

17. An ad-hoc network, including a motor vehicle near range radar comprising a number of individual radars (2, 2′) for an all around view and a control unit (3, 3′) for controlling the individual radars (2, 2′), wherein the individual radars (2, 2′) are designed to be operated in a sensory mode and in a communication mode, and wherein the control unit (3, 3′) is designed to switch at least one individual radar (2, 2′) to the communication mode as soon as a contact vehicle (1, 1′) enters the range of the motor vehicle near range radar.

18. A cellular network, including a motor vehicle near range radar comprising a number of individual radars (2, 2′) for an all around view and a control unit (3, 3′) for controlling the individual radars (2, 2′), wherein the individual radars (2, 2′) are designed to be operated in a sensory mode and in a communication mode, and wherein the control unit (3, 3′) is designed to switch at least one individual radar (2, 2′) to the communication mode as soon as a contact vehicle (1, 1′) enters the range of the motor vehicle near range radar.

19. A process for operating a motor vehicle near range radar with at least one individual radar and a control unit for control of the at least one individual radar such that it can be switched between a sensing mode and a communication mode, wherein the near range radar is equipped, for an all around view, with a number of individual radars (2, 2′) and wherein the process comprises the following steps:
operating the individual radars (2, 2′) in a sensing mode as long as no contact vehicle (1, 1′) enters the range of the motor vehicle near range radar; and
switching at least one individual radar (2, 2′) into a communication mode as soon as a contact vehicle (1, 1′) enters the range of the motor vehicle near range radar.

20. A process according to claim 19, wherein the switching over of the at least one individual radar (1, 1′) into the communication mode occurs only so long as the contact vehicle (1, 1′) is in the range of the motor vehicle near range radar, and wherein, following departure of the contact vehicle (1, 1′) from the range of the motor vehicle near range radar, said at least one individual radar (2, 2′) is operated in the sensory mode.

21. A process according to claim 19, wherein communication in the communication mode is established on the basis of a communication protocol.

22. A process according to claim 20, wherein the motor vehicle near range radar is adapted for communication with one or more individual radars (4) positionally fixed along the edge of a road, which are likewise switched to a communication mode as soon as the motor vehicle (1, 1′) enters the range of the fixed individual radar (4).
